(19) United States
(12) Patent Application Publication
(10) Pub. No.: US 2017/0030802 A1
(43) Pub. Date: Feb. 2, 2017

(54) Apparatus and Method for Measuring Group Velocity Delay in Optical Waveguide

(71) Applicant: Huawei Technologies Co., Ltd., Shenzhen (CN)

(72) Inventors: Wanyuan Liu, Wuhan (CN); Hongyan Fu, Shenzhen (CN); Xin Tu, Wuhan (CN)

(21) Appl. No.: 15/293,904

(22) Filed: Oct. 14, 2016

Related U.S. Application Data
(63) Continuation of application No. PCT/CN2014/075388, filed on Apr. 15, 2014.

(51) Int. Cl. G01M 11/00; H04B 10/073

(52) U.S. Cl. CPC G01M 11/33; H04B 10/073

(57) ABSTRACT

An apparatus is provided. The apparatus includes: a first main waveguide, configured to input and output a first optical signal; a first to-be-tested waveguide, configured to couple the first optical signal to generate a second optical signal, and transfer the second optical signal, an optical signal that is reflected by a second fiber Bragg grating, and an optical signal that is reflected by a first fiber Bragg grating. The apparatus also includes the first fiber Bragg grating, configured to totally reflect the optical signal that is reflected by the second fiber Bragg grating; the second fiber Bragg grating, configured to partially transmit and partially reflect the second optical signal and the optical signal that is reflected by the first fiber Bragg grating; and a first photoelectric detector, configured to receive an optical signal that is transmitted by the second fiber Bragg grating of the corresponding first to-be-tested waveguide.

### CROSS-REFERENCE TO RELATED APPLICATIONS

This application is a continuation of International Application No. PCT/CN2014/075388, filed on Apr. 15, 2014, the disclosure of which is hereby incorporated by reference in its entirety.

### TECHNICAL FIELD

The present invention relates to the field of communications technologies, and in particular, to an apparatus and a method for measuring a group velocity delay in an optical waveguide.

### BACKGROUND

The advent of the first laser brought a far-reaching change to human communication. Light, acting as an information carrier, features a high speed and stability, which helps people communicate with each other in a more timely and convenient manner. Silicon photonics draws intensive attention because it is compatible with a circuit process, and people expect that silicon-based integrated optics can get the same development as electricity.

In a silicon photonic chip, a group refractive index of an optical wave is determined by three main factors: a wafer thickness, a waveguide width, and temperature. The wafer thickness and the waveguide width change randomly in an actual production process, resulting in a change of the group refractive index of the optical wave. Consequently, a group propagation velocity of the optical wave in an optical waveguide changes, and then a delay phenomenon for light occurs at a receive end.

In an actual communications system, there is a strict requirement for a delay of an optical wave. For example, a maximum delay that can be supported in a 100 Gbit/s coherent system is 4 ps. For a large optical component, for example, a switch matrix, a distance traveled by an optical wave is usually greater than 10 centimeters; therefore, limiting the delay within 4 ps is a relatively high requirement. In this case, we need to take a problem of a group velocity delay in a silicon optical waveguide seriously, and it is necessary and urgent to measure the group velocity delay in the silicon optical waveguide.

FIG. 1 is a schematic structural diagram of an existing apparatus for measuring a group velocity delay in an optical waveguide. As shown in FIG. 1, the apparatus, based on a Mach-Zehnder interferometer, includes: an input waveguide 11, a first Y-shaped beam splitter 12, a first to-be-tested arm 13, a second to-be-tested arm 14, a second Y-shaped beam splitter 15, and an output waveguide 16. The first to-be-tested arm 13 and the second to-be-tested arm 14 are to-be-tested waveguides, and the two to-be-tested waveguides are designed to have a same length and a same group refractive index. Light is input by the input waveguide 11, and is split by the first Y-shaped beam splitter 12 into two beams of light of same power and of a same phase. The two beams of light are respectively transferred in the two to-be-tested waveguides. If a group refractive index difference between the two to-be-tested waveguides is caused by workmanship, different phases are accumulated for the two beams of light that formerly have the same power and the same phase. The two beams of light having a phase difference are coupled to generate one beam of light via the second Y-shaped beam splitter 15. The one beam of light is output by the output waveguide 16. The group refractive index difference between the two to-be-tested waveguides can be determined by observing and measuring a change of an interference spectrum of the light that is output by the output waveguide 16, and then group velocity delays in the two to-be-tested waveguides are determined. In addition, in an optical component, for example, in a switch array, a distance traveled by light in an optical waveguide is usually greater than to centimeters. Therefore, to emulate an actual propagation length of the light, lengths of the two to-be-tested waveguides are both 7.5 centimeters, that is, a sum of the lengths is 15 centimeters.

However, the prior art has the following disadvantages: A sum of lengths of two to-be-tested waveguides is a very large number compared with changes of a wafer thickness and a waveguide width that affect a group refractive index, and the wafer thickness and the waveguide width change randomly in an actual production process; therefore, in a large sample range, mean values of the changes of the wafer thickness and the waveguide width approach o, that is, a mean value of a group refractive index change in an optical waveguide approaches o. Consequently, a group velocity delay in an optical component cannot be tested, and an occupied chip area is relatively large.

### SUMMARY

Embodiments provide an apparatus and a method for measuring a group velocity delay in an optical waveguide, which are used to resolve a prior-art problem that due to an excessively large sum of lengths of two to-be-tested waveguides, a group velocity delay in an optical component cannot be tested and an occupied chip area is relatively large.

According to a first aspect, the embodiments provide an apparatus for measuring a group velocity delay in an optical waveguide. The apparatus includes a first main waveguide, at least two first to-be-tested waveguides of a same structure but with a different width from that of the first main waveguide, a first fiber Bragg grating that is disposed at a first end of each of the first to-be-tested waveguides, a second fiber Bragg grating that is disposed at a second end of each of the first to-be-tested waveguides, and first photoelectric detectors whose quantity is the same as that of the first to-be-tested waveguides. The first main waveguide is configured to input and output a first optical signal. The first to-be-tested waveguide is configured to: couple the first optical signal to generate a second optical signal, and transfer the second optical signal, an optical signal that is reflected by the second fiber Bragg grating, and an optical signal that is reflected by the first fiber Bragg grating. The first fiber Bragg grating is configured to totally reflect the optical signal that is reflected by the second fiber Bragg grating. The second fiber Bragg grating is configured to partially transmit and partially reflect the second optical signal and the optical signal that is reflected by the first fiber Bragg grating. The first photoelectric detector is configured to receive an optical signal that is transmitted by the second fiber Bragg grating of the corresponding first to-be-tested waveguide.

In a first possible implementation manner of the first aspect, the second fiber Bragg grating is specifically configured to transmit 5% of and reflect 95% of the optical signal that is reflected by the first fiber Bragg grating.

With reference to the first possible implementation manner of the first aspect, in a second possible implementation manner, the first main waveguide is a straight waveguide.

With reference to the second possible implementation manner of the first aspect, in a third possible implementation manner, the first to-be-tested waveguides are straight waveguides.

With reference to the third possible implementation manner of the first aspect, in a fourth possible implementation manner, the first to-be-tested waveguides and the first main waveguide are parallel.

With reference to the fourth possible implementation manner of the first aspect, in a fifth possible implementation manner, distances from any two of the first to-be-tested waveguides to the first main waveguide are equal.

According to a second aspect, the embodiments provide an apparatus for measuring a group velocity delay in an optical waveguide, including: a second main waveguide, a beam splitter, two third main waveguides of a same structure and with a same group refractive index, a coupler, a fourth main waveguide, at least one to-be-tested waveguide unit, and a second photoelectric detector whose quantity is the same as that of the to-be-tested waveguide unit, where the to-be-tested waveguide unit includes: two second to-be-tested waveguides of a same structure but with a different width from that of the third main waveguides, a middle waveguide with a same width as that of the second to-be-tested waveguides, a third fiber Bragg grating that is disposed at a first end of each of the second to-be-tested waveguides, and a fourth fiber Bragg grating that is disposed at a second end of each of the second to-be-tested waveguides. The second main waveguide is configured to input a third optical signal. The beam splitter is configured to split the third optical signal that is output by the second main waveguide into two fourth optical signals of a same phase and same power. Each third main waveguide is configured to input and output one of the fourth optical signals output by the beam splitter. The coupler is configured to couple the two fourth optical signals output by the two third main waveguides, to generate a fifth optical signal. The fourth main waveguide is configured to output the fifth optical signal output by the coupler. The second to-be-tested waveguide is configured to: couple the fourth optical signal in the corresponding third main waveguide to generate a sixth optical signal, and transfer the sixth optical signal, an optical signal that is reflected by the fourth fiber Bragg grating, and an optical signal that is reflected by the third fiber Bragg grating. The third fiber Bragg grating is configured to totally reflect the optical signal that is reflected by the fourth fiber Bragg grating. The fourth fiber Bragg grating is configured to partially transmit and partially reflect the sixth optical signal and the optical signal that is reflected by the third fiber Bragg grating. The middle waveguide is configured to input and output an optical signal that is transmitted by the fourth fiber Bragg gratings of the two second to-be-tested waveguides in the same to-be-tested waveguide unit. The second photoelectric detector is configured to receive the optical signal output by the middle waveguide in the corresponding to-be-tested waveguide unit.

In a first possible implementation manner of the second aspect, the fourth fiber Bragg grating is specifically configured to transmit 5% of and reflect 95% of the optical signal that is reflected by the third fiber Bragg grating.

With reference to the first possible implementation manner of the second aspect, in a second possible implementation manner, the third main waveguides are straight waveguides.

With reference to the second possible implementation manner of the second aspect, in a third possible implementation manner, the two third main waveguides are parallel to each other.

With reference to the third possible implementation manner of the second aspect, in a fourth possible implementation manner, the second to-be-tested waveguides are bended waveguides.

With reference to the fourth possible implementation manner of the second aspect, in a fifth possible implementation manner, the first end and the second end of the second to-be-tested waveguide are separately parallel to the third main waveguide.

With reference to the fifth possible implementation manner of the second aspect, in a sixth possible implementation manner, the middle waveguide is a straight waveguide.

With reference to the sixth possible implementation manner of the second aspect, in a seventh possible implementation manner, the middle waveguide is parallel to the third main waveguides.

With reference to the seventh possible implementation manner of the second aspect, in an eighth possible implementation manner, distances from the two second to-be-tested waveguides in the same to-be-tested waveguide unit to the respectively corresponding third main waveguides are equal.

With reference to the eighth possible implementation manner of the second aspect, in a ninth possible implementation manner, distances from the two second to-be-tested waveguides in the same to-be-tested waveguide unit to the corresponding middle waveguide are equal.

According to a third aspect, the embodiments provide a method for measuring a group velocity delay in an optical waveguide, including: inputting and outputting, by a first main waveguide, a first optical signal. The method also includes coupling, by a first to-be-tested waveguide, the first optical signal to generate a second optical signal, and transferring the second optical signal, an optical signal that is reflected by a second fiber Bragg grating, and an optical signal that is reflected by a first fiber Bragg grating. The method also includes totally reflecting, by the first fiber Bragg grating, the optical signal that is reflected by the second fiber Bragg grating. The method also includes partially transmitting and partially reflecting, by the second fiber Bragg grating, the second optical signal and the optical signal that is reflected by the first fiber Bragg grating. The method also includes receiving, by a first photoelectric detector, an optical signal that is transmitted by the second fiber Bragg grating of the corresponding first to-be-tested waveguide. There are at least two first to-be-tested waveguides, and the at least two first to-be-tested waveguides are of a same structure but have a different width from that of the first main waveguide. The first fiber Bragg grating is disposed at a first end of the first to-be-tested waveguide. The second fiber Bragg grating is disposed at a second end of the first to-be-tested waveguide. A quantity of the first photoelectric detectors is the same as the quantity of the first to-be-tested waveguides.

In a first possible implementation manner of the third aspect, the partially transmitting and partially reflecting, by the second fiber Bragg grating, the optical signal that is reflected by the first fiber Bragg grating is specifically transmitting and reflecting, by the second fiber Bragg grating, 5% and 95% respectively of the optical signal that is reflected by the first fiber Bragg grating.

According to a fourth aspect, the embodiments provide a method for measuring a group velocity delay in an optical waveguide. The method includes inputting, by a second main waveguide, a third optical signal. The method also includes splitting, by a beam splitter, the third optical signal that is output by the second main waveguide into two fourth optical signals of a same phase and same power. The method also includes inputting and outputting, by each third main waveguide, one of the fourth optical signals output by the beam splitter. The method also includes coupling, by a coupler, the two fourth optical signals output by the two third main waveguides, to generate a fifth optical signal. The method also includes outputting, by a fourth main waveguide, the fifth optical signal output by the coupler. The method also includes coupling, by a second to-be-tested waveguide, the fourth optical signal in the corresponding third main waveguide to generate a sixth optical signal, and transferring the sixth optical signal, an optical signal that is reflected by a fourth fiber Bragg grating, and an optical signal that is reflected by a third fiber Bragg grating. The method also includes totally reflecting, by the third fiber Bragg grating, the optical signal that is reflected by the fourth fiber Bragg grating. The method also includes partially transmitting and partially reflecting, by the fourth fiber Bragg grating, the sixth optical signal and the optical signal that is reflected by the third fiber Bragg grating. The method also includes inputting and outputting, by a middle waveguide, an optical signal that is transmitted by fourth fiber Bragg gratings of two second to-be-tested waveguides in a same to-be-tested waveguide unit. The method also includes receiving, by a second photoelectric detector, the optical signal output by the middle waveguide in the corresponding to-be-tested waveguide unit. There are two third main waveguides, and the two third main waveguides are of a same structure and with a same group refractive index. There is at least one to-be-tested waveguide unit, and the to-be-tested waveguide unit includes: the two second to-be-tested waveguides of a same structure but with a different width from that of the third main waveguides, the middle waveguide with a same width as that of the second to-be-tested waveguides, the third fiber Bragg grating that is disposed at a first end of each of the second to-be-tested waveguides, and the fourth fiber Bragg grating that is disposed at a second end of each of the second to-be-tested waveguides. A quantity of the second photoelectric detectors is the same as the quantity of the to-be-tested waveguide units.

In a first possible implementation manner of the fourth aspect, the partially transmitting and partially reflecting, by the fourth fiber Bragg grating, the optical signal that is reflected by the third fiber Bragg grating is specifically transmitting and reflecting, by the fourth fiber Bragg grating, 5% and 95% respectively of the optical signal that is reflected by the third fiber Bragg grating.

According to the apparatus and the method for measuring a group velocity delay in an optical waveguide that are provided in the embodiments, a waveguide is used as a to-be-tested waveguide, where a fiber Bragg grating for total reflection and a fiber Bragg grating for partial reflection and partial transmission are respectively disposed at two ends of the waveguide, and light is transferred, in the to-be-tested waveguide, back and forth for multiple times by using the two fiber Bragg gratings for output. In this way, an actual propagation length of the light in an optical component may be emulated by using a relatively short to-be-tested waveguide, and a group refractive index difference between to-be-tested waveguides is amplified after the light is transferred back and forth. Therefore, it is convenient to test a group velocity delay in the optical component, and an occupied chip area is relatively small.

### BRIEF DESCRIPTION OF THE DRAWINGS

To describe the technical solutions in the embodiments of the present invention or in the prior art more clearly, the following briefly describes the accompanying drawings required for describing the embodiments or the prior art. Apparently, the accompanying drawings in the following description show some embodiments of the present invention, and persons of ordinary skill in the art may still derive other drawings from these accompanying drawings without creative efforts.

FIG. 1 is a schematic structural diagram of an existing apparatus for measuring a group velocity delay in an optical waveguide;

FIG. 2 is a schematic structural diagram of an embodiment of an apparatus for measuring a group velocity delay in an optical waveguide according to an embodiment;

FIG. 3 is a schematic structural diagram of another embodiment of an apparatus for measuring a group velocity delay in an optical waveguide according to an embodiment;

FIG. 4 is a schematic flowchart of an embodiment of a method for measuring a group velocity delay in an optical waveguide according to an embodiment; and

FIG. 5 is a schematic flowchart of another embodiment of a method for measuring a group velocity delay in an optical waveguide according to an embodiment.

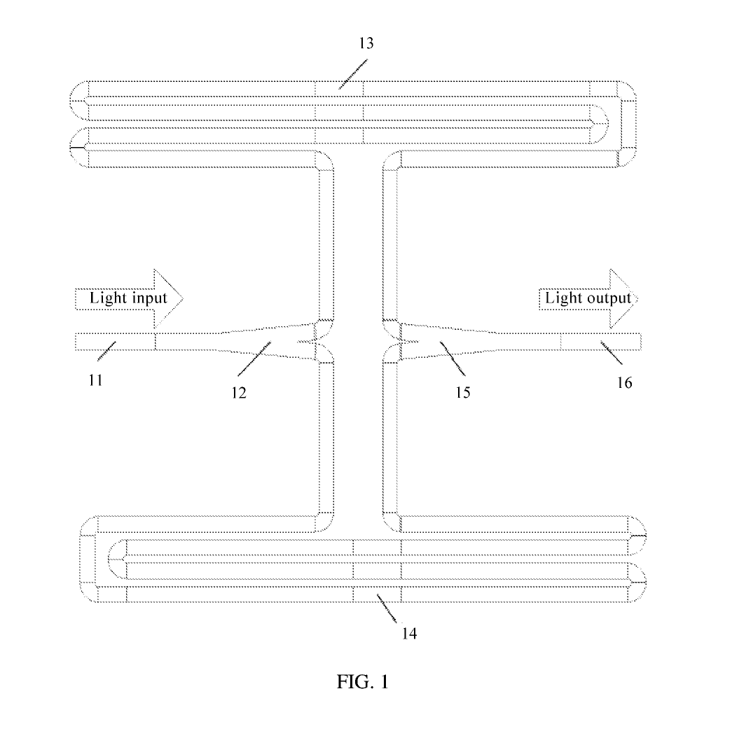

### DETAILED DESCRIPTION OF ILLUSTRATIVE EMBODIMENTS

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention without creative efforts shall fall within the protection scope of the present invention.

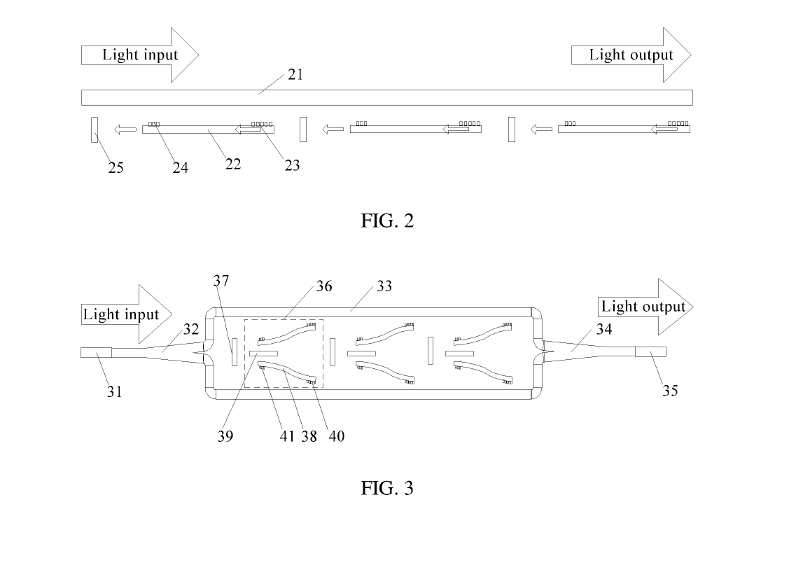

FIG. 2 is a schematic structural diagram of an embodiment of an apparatus for measuring a group velocity delay in an optical waveguide according to embodiments. As shown in FIG. 2, the apparatus may specifically include: a first main waveguide 21, at least two first to-be-tested waveguides 22 of a same structure but with a different width from that of the first main waveguide, a first fiber Bragg grating 23 that is disposed at a first end of each of the first to-be-tested waveguides, a second fiber Bragg grating 24 that is disposed at a second end of each of the first to-be-tested waveguides, and first photoelectric detectors 25 whose quantity is the same as that of the first to-be-tested waveguides.

The first main waveguide 21 is configured to input and output a first optical signal.

The first to-be-tested waveguide 22 is configured to: couple the first optical signal to generate a second optical signal, and transfer the second optical signal, an optical signal that is reflected by the second fiber Bragg grating 24, and an optical signal that is reflected by the first fiber Bragg grating 23.

The first fiber Bragg grating 23 is configured to totally reflect the optical signal that is reflected by the second fiber Bragg grating 24.

The second fiber Bragg grating 24 is configured to partially transmit and partially reflect the second optical signal and the optical signal that is reflected by the first fiber Bragg grating 23.

The first photoelectric detector 25 is configured to receive an optical signal that is transmitted by the second fiber Bragg grating of the corresponding first to-be-tested waveguide.

Specifically, an apparatus implementing measurement of a group velocity delay in an optical waveguide by means of self mutual interference between to-be-tested waveguides is described in this embodiment.

A working principle of the apparatus for measuring a group velocity delay in an optical waveguide in this embodiment is as follows:

The first main waveguide 21 serves as a peripheral waveguide, inputs and outputs the first optical signal, and provides optical signal input and output for the entire apparatus. The first optical signal is transferred in the first main waveguide 21, and coupling occurs when the first optical signal goes through the first end of the first to-be-tested waveguide 22. An extension direction from the first end to the second end of the first to-be-tested waveguide 22 and a direction in which the first optical signal is transferred in the first main waveguide 21 are opposite or form an obtuse angle. The optical signal is coupled from the first main waveguide 21 into the first to-be-tested waveguide 22. Such type of coupling is reverse coupling because the width of the first to-be-tested waveguide 22 is different from that of the first main waveguide 21. That is, the second optical signal that is excited by the first to-be-tested waveguide 22 is transferred from the first end to the second end of the first to-be-tested waveguide 22, where power of the second optical signal may be obtained by adjusting a spacing between the first to-be-tested waveguide 22 and the first main waveguide 21 or by adjusting an etching depth of the first fiber Bragg grating 23 etched at the first end of the first to-be-tested waveguide 22. The second fiber Bragg grating 24 etched at the second end of the first to-be-tested waveguide 22 partially transmits and partially reflects the second optical signal, for example, transmits 5% of and reflects 95% of the second optical signal. An optical signal that is partially reflected by the second fiber Bragg grating 24 is transferred from the second end to the first end of the first to-be-tested waveguide 22. The first fiber Bragg grating 23 etched at the first end of the first to-be-tested waveguide 22 totally reflects the optical signal that is partially reflected by the second fiber Bragg grating 24, that is, reflects 100% of the optical signal. The optical signal that is totally reflected by the first fiber Bragg grating 23 is transferred from the first end to the second end of the first to-be-tested waveguide 22. The second fiber Bragg grating 24 etched at the second end of the first to-be-tested waveguide 22 partially transmits and partially reflects the optical signal that is totally reflected by the first fiber Bragg grating 23. In this way, a relatively small group refractive index change of the first to-be-tested waveguides 22 is amplified after an optical signal is transferred back and forth. An optical signal that is transmitted by the second fiber Bragg grating 24 is received by the first photoelectric detector 25, so as to form an interference spectrum. A user may determine a group refractive index difference between any two to-be-tested waveguides by observing and measuring changes of interference spectra that are respectively corresponding to the two to-be-tested waveguides, and then determine group velocity delays in the two to-be-tested waveguides, that is, a group velocity delay in an optical component using such type of waveguide.

The first main waveguide 21 may be specifically a straight waveguide or a bended waveguide. The first to-be-tested waveguides 22 may be specifically straight waveguides or bended waveguides. If the first main waveguide 21 and the first to-be-tested waveguides 22 are all straight waveguides, the first to-be-tested waveguides 22 may be disposed parallel to the first main waveguide 21, and any two of the first to-be-tested waveguides 22 may be disposed at a same distance from the first main waveguide 21.

According to the apparatus for measuring a group velocity delay in an optical waveguide provided in this embodiment, a waveguide is used as a to-be-tested waveguide, where a fiber Bragg grating for total reflection and a fiber Bragg grating for partial reflection and partial transmission are respectively disposed at two ends of the waveguide, and light is transferred, in the to-be-tested waveguide, back and forth for multiple times by using the two fiber Bragg gratings for output. In this way, an actual propagation length of the light in an optical component may be emulated by using a relatively short to-be-tested waveguide, and a group refractive index difference between to-be-tested waveguides is amplified after the light is transferred back and forth. Therefore, it is convenient to test a group velocity delay in the optical component, and an occupied chip area is relatively small.

FIG. 3 is a schematic structural diagram of another embodiment of an apparatus for measuring a group velocity delay in an optical waveguide according to the embodiments. As shown in FIG. 3, the apparatus may specifically include: a second main waveguide 31, a beam splitter 32, two third main waveguides 33 of a same structure and with a same group refractive index, a coupler 34, a fourth main waveguide 35, at least one to-be-tested waveguide unit 36, and a second photoelectric detector 37 whose quantity is the same as that of the to-be-tested waveguide unit 36. The to-be-tested waveguide unit 36 includes: two second to-be-tested waveguides 38 of a same structure but with a different width from that of the third main waveguides 33, a middle waveguide 39 with a same width as that of the second to-be-tested waveguides 38, a third fiber Bragg grating 40 that is disposed at a first end of each of the second to-be-tested waveguides 38, and a fourth fiber Bragg grating 41 that is disposed at a second end of each of the second to-be-tested waveguides 38.

The second main waveguide 31 is configured to input a third optical signal.

The beam splitter 32 is configured to split the third optical signal that is output by the second main waveguide 31 into two fourth optical signals of a same phase and same power.

Each third main waveguide 33 is configured to input and output one of the fourth optical signals output by the beam splitter 32.

The coupler 34 is configured to couple the two fourth optical signals output by the two third main waveguides 33, to generate a fifth optical signal.

The fourth main waveguide 35 is configured to output the fifth optical signal output by the coupler 34.

The second to-be-tested waveguide 38 is configured to: couple the fourth optical signal in the corresponding third main waveguide 33 to generate a sixth optical signal, and transfer the sixth optical signal, an optical signal that is reflected by the fourth fiber Bragg grating 41, and an optical signal that is reflected by the third fiber Bragg grating 40.

The third fiber Bragg grating 40 is configured to totally reflect the optical signal that is reflected by the fourth fiber Bragg grating 41.

The fourth fiber Bragg grating 41 is configured to partially transmit and partially reflect the sixth optical signal and the optical signal that is reflected by the third fiber Bragg grating 40.

The middle waveguide 39 is configured to input and output an optical signal that is transmitted by the fourth fiber Bragg gratings 41 of the two second to-be-tested waveguides 38 in the same to-be-tested waveguide unit 36.

The second photoelectric detector 37 is configured to receive the optical signal output by the middle waveguide 39 in the corresponding to-be-tested waveguide unit 36.

Specifically, an apparatus implementing measurement of a group velocity delay in an optical waveguide by means of mutual interference between two to-be-tested waveguides is described in this embodiment.

A working principle of the apparatus for measuring a group velocity delay in an optical waveguide in this embodiment is as follows:

The second main waveguide 31, the beam splitter 32, the two third main waveguides 33 of the same structure and with the same group refractive index, the coupler 34, and the fourth main waveguide 35 all serve as peripheral waveguides, and provide optical signal input and output for the entire apparatus. The third optical signal is input by the second main waveguide 31, and is split, by the beam splitter 32, into the two fourth optical signals of the same phase and same power. The two fourth optical signals are transferred along the corresponding third main waveguides 33 respectively, and are coupled by the coupler 34 to generate the fifth optical signal. Each fourth optical signal is transferred in the corresponding third main waveguide 33, and coupling occurs when the fourth optical signal goes through the first end of the second to-be-tested waveguide 38. An extension direction from the first end to the second end of the second to-be-tested waveguide 38 and a direction in which the fourth optical signal is transferred in the third main waveguide 33 are opposite or form an obtuse angle. The optical signal is coupled from the third main waveguide 33 into the second to-be-tested waveguide 38. Such type of coupling is reverse coupling because the width of the second to-be-tested waveguide 38 is different from the width of the third main waveguide 33. That is, the sixth optical signal that is excited by each second to-be-tested waveguide 38 is transferred from the first end to the second end of the second to-be-tested waveguide 38, where power of the sixth optical signal may be obtained by adjusting a spacing between the second to-be-tested waveguide 38 and the third main waveguide 33 or by adjusting an etching depth of the third fiber Bragg grating 40 etched at the first end of the second to-be-tested waveguide 38. The fourth fiber Bragg grating 41 etched at the second end of the second to-be-tested waveguide 38 partially transmits and partially reflects the sixth optical signal, for example, transmits 5% of and reflects 95% of the sixth optical signal. An optical signal that is partially reflected by the fourth fiber Bragg grating 41 is transferred from the second end to the first end of the second to-be-tested waveguide 38. The third fiber Bragg grating 40 etched at the first end of the second to-be-tested waveguide 38 totally reflects the optical signal that is partially reflected by the fourth fiber Bragg grating 41, that is, reflects 100% the optical signal. The optical signal that is totally reflected by the third fiber Bragg grating 40 is transferred from the first end to the second end of the second to-be-tested waveguide 38. The fourth fiber Bragg grating 41 etched at the second end of the second to-be-tested waveguide 38 partially transmits and partially reflects the optical signal that is totally reflected by the third fiber Bragg grating 40. In this way, a relatively small group refractive index change of the second to-be-tested waveguides 38 is amplified after an optical signal is transferred back and forth. Two optical signals that are transmitted by the fourth fiber Bragg gratings 41 of the two second to-be-tested waveguides 38 in the same to-be-tested waveguide unit 36 interfered with each other in the middle waveguide 39. The optical signal output by the middle waveguide 39 is received by the second photoelectric detector 37, so as to form an interference spectrum. A user may determine a group refractive index difference between the two to-be-tested waveguides in the to-be-tested waveguide unit 36 by observing and measuring a change of the interference spectrum corresponding to the to-be-tested waveguide unit 36, and then determine group velocity delays in the two to-be-tested waveguides, that is, determine a group velocity delay in an optical component using such type of waveguide.

The two third main waveguides 33 may be specifically straight waveguides or bended waveguides. If the two third main waveguides 33 are both straight waveguides, the two third main waveguides 33 may be disposed parallel to each other. The second to-be-tested waveguides 38 may be specifically straight waveguides or bended waveguides. If the second to-be-tested waveguides 38 are bended waveguides, the first end and the second end of the second to-be-tested waveguide 38 are separately disposed parallel to the third main waveguide 33. The middle waveguide 39 may be specifically a straight waveguide or a bended waveguide. If the middle waveguide 39 is a straight waveguide, and the two third main waveguides 33 are also straight waveguides, the middle waveguide 39 may be disposed parallel to the third main waveguides 33. The two second to-be-tested waveguides 38 in the same to-be-tested waveguide unit 36 may be disposed at a same distance from the respectively corresponding third main waveguides 33, and may further be disposed at a same distance from the corresponding middle waveguide 39.

According to the apparatus for measuring a group velocity delay in an optical waveguide provided in this embodiment, a waveguide is used as a to-be-tested waveguide, where a fiber Bragg grating for total reflection and a fiber Bragg grating for partial reflection and partial transmission are respectively disposed at two ends of the waveguide, and light is transferred, in the to-be-tested waveguide, back and forth for multiple times by using the two fiber Bragg gratings for output. In this way, an actual propagation length of the light in an optical component may be emulated by using a relatively short to-be-tested waveguide, and a group refractive index difference between to-be-tested waveguides is amplified after the light is transferred back and forth. Therefore, it is convenient to test a group velocity delay in the optical component, and an occupied chip area is relatively small.

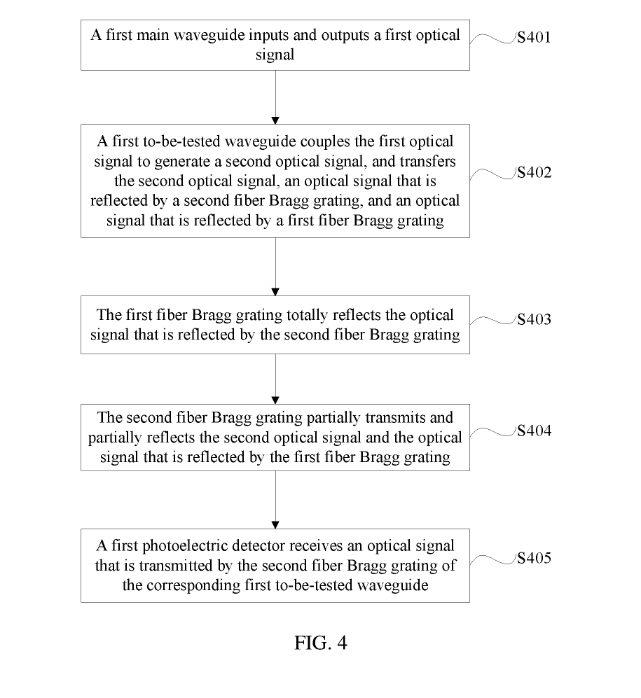

FIG. 4 is a schematic flowchart of an embodiment of a method for measuring a group velocity delay in an optical waveguide according to the embodiments. As shown in FIG. 4, the method may be implemented by the apparatus for measuring a group velocity delay in an optical waveguide in the embodiment shown in FIG. 2, where the method may specifically include the following steps.

S401. A first main waveguide inputs and outputs a first optical signal.

S402. A first to-be-tested waveguide couples the first optical signal to generate a second optical signal, and transfers the second optical signal, an optical signal that is reflected by a second fiber Bragg grating, and an optical signal that is reflected by a first fiber Bragg grating.

S403. The first fiber Bragg grating totally reflects the optical signal that is reflected by the second fiber Bragg grating.

S404. The second fiber Bragg grating partially transmits and partially reflects the second optical signal and the optical signal that is reflected by the first fiber Bragg grating.

Specifically, the second fiber Bragg grating may transmit 5% of and reflect 95% of the optical signal that is reflected by the first fiber Bragg grating.

S405. A first photoelectric detector receives an optical signal that is transmitted by the second fiber Bragg grating of the corresponding first to-be-tested waveguide.

There are at least two first to-be-tested waveguides, and the at least two first to-be-tested waveguides are of a same structure but have a different width from that of the first main waveguide. The first fiber Bragg grating is disposed at a first end of the first to-be-tested waveguide. The second fiber Bragg grating is disposed at a second end of the first to-be-tested waveguide. A quantity of the first photoelectric detectors is the same as the quantity of the first to-be-tested waveguides.

Specifically, for specific implementation processes of the steps, reference may be made to related description in the embodiment shown in FIG. 2, and details are not described herein.

According to the method for measuring a group velocity delay in an optical waveguide provided in this embodiment, a waveguide is used as a to-be-tested waveguide, where a fiber Bragg grating for total reflection and a fiber Bragg grating for partial reflection and partial transmission are respectively disposed at two ends of the waveguide, and light is transferred, in the to-be-tested waveguide, back and forth for multiple times by using the two fiber Bragg gratings for output. In this way, an actual propagation length of the light in an optical component may be emulated by using a relatively short to-be-tested waveguide, and a group refractive index difference between to-be-tested waveguides is amplified after the light is transferred back and forth. Therefore, it is convenient to test a group velocity delay in the optical component, and an occupied chip area is relatively small.

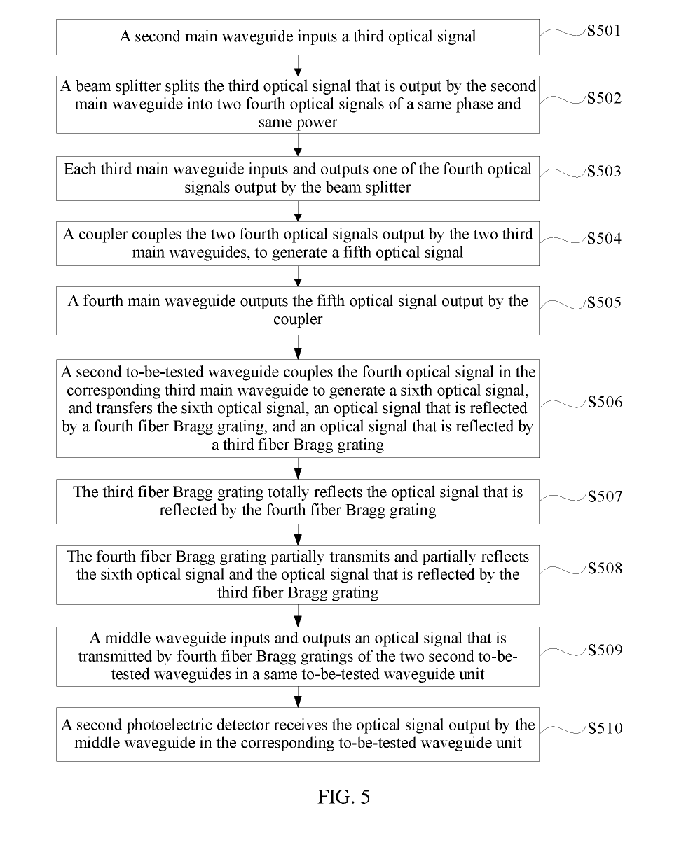

FIG. 5 is a schematic flowchart of another embodiment of a method for measuring a group velocity delay in an optical waveguide according to the embodiments. As shown in FIG. 5, the method may be implemented by the apparatus for measuring a group velocity delay in an optical waveguide in the embodiment shown in FIG. 3, where the method may specifically include the following steps.

S501. A second main waveguide inputs a third optical signal.

S502. A beam splitter splits the third optical signal that is output by the second main waveguide into two fourth optical signals of a same phase and same power.

S503. Each third main waveguide inputs and outputs one of the fourth optical signals output by the beam splitter.

S504. A coupler couples the two fourth optical signals output by the two third main waveguides, to generate a fifth optical signal.

S505. A fourth main waveguide outputs the fifth optical signal output by the coupler.

S506. A second to-be-tested waveguide couples the fourth optical signal in the corresponding third main waveguide to generate a sixth optical signal, and transfers the sixth optical signal, an optical signal that is reflected by a fourth fiber Bragg grating, and an optical signal that is reflected by a third fiber Bragg grating.

S507. The third fiber Bragg grating totally reflects the optical signal that is reflected by the fourth fiber Bragg grating.

S508. The fourth fiber Bragg grating partially transmits and partially reflects the sixth optical signal and the optical signal that is reflected by the third fiber Bragg grating.

Specifically, the fourth fiber Bragg grating may transmit 5% of and reflect 95% of the optical signal that is reflected by the third fiber Bragg grating.

S509. A middle waveguide inputs and outputs an optical signal that is transmitted by fourth fiber Bragg gratings of two second to-be-tested waveguides in a same to-be-tested waveguide unit.

S510. A second photoelectric detector receives the optical signal output by the middle waveguide in the corresponding to-be-tested waveguide unit.

There are two third main waveguides, and the two third main waveguides are of a same structure and with a same group refractive index. There is at least one to-be-tested waveguide unit, and the to-be-tested waveguide unit includes: the two second to-be-tested waveguides of a same structure but with a different width from that of the third main waveguides, the middle waveguide with a same width as that of the second to-be-tested waveguides, the third fiber Bragg grating that is disposed at a first end of each of the second to-be-tested waveguides, and the fourth fiber Bragg grating that is disposed at a second end of each of the second to-be-tested waveguides. A quantity of the second photoelectric detectors is the same as the quantity of the to-be-tested waveguide units.

Specifically, for specific implementation processes of the steps, reference may be made to related description in the embodiment shown in FIG. 3, and details are not described herein.

According to the method for measuring a group velocity delay in an optical waveguide provided in this embodiment, a waveguide is used as a to-be-tested waveguide, where a fiber Bragg grating for total reflection and a fiber Bragg grating for partial reflection and partial transmission are respectively disposed at two ends of the waveguide, and light is transferred, in the to-be-tested waveguide, back and forth for multiple times by using the two fiber Bragg gratings for output. In this way, an actual propagation length of the light in an optical component may be emulated by using a relatively short to-be-tested waveguide, and a group refractive index difference between to-be-tested waveguides is amplified after the light is transferred back and forth. Therefore, it is convenient to test a group velocity delay in the optical component, and an occupied chip area is relatively small.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended to describe the technical solutions of the present invention, but not to limit the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. An apparatus, comprising:
a first main waveguide, configured to input and output a first optical signal;
a plurality of first to-be-tested waveguides, each of the plurality of first to-be-tested waveguides having a same structure but a different width from that of the first main waveguide;
a plurality of first fiber Bragg gratings, wherein a first fiber Bragg grating is disposed at a first end of each of the plurality of first to-be-tested waveguides;
a plurality of second fiber Bragg gratings, wherein a second fiber Bragg grating is disposed at a second end of each of the plurality of first to-be-tested waveguides; and
a plurality of first photoelectric detectors, wherein a quantity of the plurality of first photoelectric detectors is the same as a quantity of the plurality of first to-be-tested waveguides;
wherein each of the plurality of first to-be-tested waveguides is configured to couple the first optical signal to generate a second optical signal, and transfer the second optical signal, an optical signal that is reflected by a second fiber Bragg grating, and an optical signal that is reflected by a first fiber Bragg grating;
wherein each first fiber Bragg grating is configured to totally reflect the optical signal that is reflected by a corresponding second fiber Bragg grating;
wherein each second fiber Bragg grating is configured to partially transmit and partially reflect the second optical signal and the optical signal that is reflected by a corresponding first fiber Bragg grating; and
wherein each of the plurality of first photoelectric detectors is configured to receive an optical signal that is transmitted by ta second fiber Bragg grating of a corresponding first to-be-tested waveguide.

2. The apparatus according to claim 1, wherein each of the plurality of second fiber Bragg gratings is configured to transmit 5% of and reflect 95% of the optical signal that is reflected by the corresponding first fiber Bragg grating.

3. The apparatus according to claim 1, wherein the first main waveguide is a straight waveguide.

4. The apparatus according to claim 3, wherein the plurality of first to-be-tested waveguides are straight waveguides.

5. The apparatus according to claim 4, wherein the plurality of first to-be-tested waveguides and the first main waveguide are parallel.

6. The apparatus according to claim 5, wherein distances from any two of the plurality of first to-be-tested waveguides to the first main waveguide are equal.

7. An apparatus, comprising:
a second main waveguide, configured to input a third optical signal;
a beam splitter, configured to split the third optical signal that is output by the second main waveguide into a plurality of fourth optical signals of a same phase and same power;
a plurality of third main waveguides, the plurality of third main waveguides having a same structure and a same group refractive index, wherein each third main waveguide is configured to input and output one of the fourth optical signals output by the beam splitter;
a coupler, configured to couple the plurality of fourth optical signals output by the third main waveguides, to generate a fifth optical signal;
a fourth main waveguide, configured to output the fifth optical signal output by the coupler;
a to-be-tested waveguide unit, comprising:
a plurality of second to-be-tested waveguides, the second to-be-tested waveguides having a same structure but a different width from that of the plurality of third main waveguides;
a middle waveguide with a same width as that of the plurality of second to-be-tested waveguides,
a plurality of third fiber Bragg gratings, wherein a third fiber Bragg grating is disposed at a first end of each of the plurality of second to-be-tested waveguides; and
a plurality of fourth fiber Bragg gratings, wherein a fourth fiber Bragg grating is disposed at a second end of each of the second to-be-tested waveguides; and
a second photoelectric detector;
wherein each of the plurality of second to-be-tested waveguides is configured to: couple a fourth optical signal in a corresponding third main waveguide to generate a sixth optical signal, and transfer the sixth optical signal, an optical signal that is reflected by a corresponding fourth fiber Bragg grating, and an optical signal that is reflected by a corresponding third fiber Bragg grating;
wherein each third fiber Bragg grating is configured to totally reflect the optical signal that is reflected by a corresponding fourth fiber Bragg grating;
wherein each fourth fiber Bragg grating is configured to partially transmit and partially reflect the sixth optical signal and the optical signal that is reflected by a corresponding third fiber Bragg grating;
wherein the middle waveguide is configured to input and output an optical signal that is transmitted by the plurality of fourth fiber Bragg gratings of the plurality of second to-be-tested waveguides in the to-be-tested waveguide unit; and
wherein the second photoelectric detector is configured to receive the optical signal output by the middle waveguide in the to-be-tested waveguide unit.

8. The apparatus according to claim 7, wherein each fourth fiber Bragg grating is configured to transmit 5% of and reflect 95% of the optical signal that is reflected by the corresponding third fiber Bragg grating.

9. The apparatus according to claim 7, wherein each of the plurality of third main waveguides is a straight waveguide.

10. The apparatus according to claim 9, wherein the third main waveguides are parallel to each other.

11. The apparatus according to claim 10, wherein the second to-be-tested waveguides are bended waveguides.

12. The apparatus according to claim 11, wherein the first end and the second end of the second to-be-tested waveguide are separately parallel to the third main waveguide.

13. The apparatus according to claim 12, wherein the middle waveguide is a straight waveguide.

14. The apparatus according to claim 13, wherein the middle waveguide is parallel to the third main waveguides.

15. The apparatus according to claim 14, wherein distances from the plurality of second to-be-tested waveguides in the to-be-tested waveguide unit to the corresponding third main waveguides are equal.

16. The apparatus according to claim 15, wherein distances from the plurality of second to-be-tested waveguides in the to-be-tested waveguide unit to the middle waveguide are equal.

17. A method, comprising:
inputting and outputting, by a first main waveguide, a first optical signal;
coupling, by a first to-be-tested waveguide of a plurality of first to-be-tested waveguides, the first optical signal to generate a second optical signal, and transferring the second optical signal, an optical signal that is reflected by a second fiber Bragg grating, and an optical signal that is reflected by a first fiber Bragg grating;
totally reflecting, by the first fiber Bragg grating, the optical signal that is reflected by the second fiber Bragg grating;
partially transmitting and partially reflecting, by the second fiber Bragg grating, the second optical signal and the optical signal that is reflected by the first fiber Bragg grating; and
receiving, by a first photoelectric detector, an optical signal that is transmitted by the second fiber Bragg grating of the corresponding first to-be-tested waveguide;
wherein each of the plurality of first to-be-tested waveguides have a same structure as but a different width as that of the first main waveguide;
the first fiber Bragg grating is disposed at a first end of the first to-be-tested waveguide;
the second fiber Bragg grating is disposed at a second end of the first to-be-tested waveguide; and
a quantity of the first photoelectric detectors is the same as a quantity of the plurality of first to-be-tested waveguides.

18. The method according to claim 17, wherein the partially transmitting and partially reflecting, by the second fiber Bragg grating, the optical signal that is reflected by the first fiber Bragg grating comprises:
transmitting and reflecting, by the second fiber Bragg grating, 5% and 95% respectively of the optical signal that is reflected by the first fiber Bragg grating.

19. A method, comprising:
inputting, by a second main waveguide, a third optical signal;
splitting, by a beam splitter, the third optical signal that is output by the second main waveguide into a plurality of fourth optical signals of a same phase and same power;
inputting and outputting, by each of a plurality of third main waveguides, one of the fourth optical signals output by the beam splitter;
coupling, by a coupler, the plurality of fourth optical signals output by the plurality of third main waveguides, to generate a fifth optical signal;
outputting, by a fourth main waveguide, the fifth optical signal output by the coupler;
coupling, by a second to-be-tested waveguide, a fourth optical signal in a corresponding third main waveguide to generate a sixth optical signal, and transferring the sixth optical signal, an optical signal that is reflected by a fourth fiber Bragg grating, and an optical signal that is reflected by a third fiber Bragg grating;
totally reflecting, by the third fiber Bragg grating, the optical signal that is reflected by the fourth fiber Bragg grating;
partially transmitting and partially reflecting, by the fourth fiber Bragg grating, the sixth optical signal and the optical signal that is reflected by the third fiber Bragg grating;
inputting and outputting, by a middle waveguide, an optical signal that is transmitted by fourth fiber Bragg gratings of two second to-be-tested waveguides in a same to-be-tested waveguide unit; and
receiving, by a second photoelectric detector, the optical signal output by the middle waveguide in the corresponding to-be-tested waveguide unit;
wherein each of the plurality of third main waveguides are of a same structure and with a same group refractive index;
wherein there is at least one to-be-tested waveguide unit, and the to-be-tested waveguide unit comprises:
the two second to-be-tested waveguides, the second to-be-tested waveguides having a same structure but a different width from that of the third main waveguides;
the middle waveguide, the middle waveguide having a same width as that of the two second to-be-tested waveguides;
a plurality of third fiber Bragg gratings, a third fiber Bragg grating being disposed at a first end of each of the two second to-be-tested waveguides; and
a plurality of fourth fiber Bragg gratings, a fourth fiber Bragg grating being disposed at a second end of each of the second to-be-tested waveguides; and
wherein a quantity of the second photoelectric detectors is the same as a quantity of the to-be-tested waveguide units.

20. The method according to claim 19, wherein partially transmitting and partially reflecting, by the fourth fiber Bragg grating, the optical signal that is reflected by the third fiber Bragg grating comprising:
transmitting and reflecting, by the fourth fiber Bragg grating, 5% and 95% respectively of the optical signal that is reflected by the third fiber Bragg grating.
